(19) United States
(12) Patent Application Publication
(10) Pub. No.: US 2024/0160916 A1
(43) Pub. Date: May 16, 2024

(54) ARTIFICIAL INTELLIGENCE-ENABLED CROSS POLLINATION FOR PREDICTIVE YIELD

(71) Applicant: INTERNATIONAL BUSINESS MACHINES CORPORATION, ARMONK, NY (US)

(72) Inventors: Sathya Santhar, Ramapuram (IN); Sridevi Kannan, Chennai (IN); Sarbajit K. Rakshit, Kolkata (IN)

(21) Appl. No.: 18/055,877

(22) Filed: Nov. 16, 2022

(51) Int. Cl. G06N 3/08

(52) U.S. Cl. CPC G06N 3/08

(57) ABSTRACT

According to one embodiment, a method, computer system, and computer program product for flora yield prediction is provided. The embodiment may include identifying a plurality of florae and a location of each flora within the plurality of florae within a preconfigured space. The embodiment may also include identifying one or more attributes of each flora. The embodiment may further include generating a neural network model based on the plurality of florae, the location of each flora, and the one or more identified attributes. The embodiment may also include calculating tensors from an anther of each flora to one or more stigmas of each other flora within the plurality of florae based on the generated neural network model. The embodiment may further include performing cross-pollination of the plurality of florae based on the calculated tensors.

### BACKGROUND

The present invention relates generally to the field of computing, and more particularly to artificial pollination.

Pollination relates to the fertilization of a plant that occurs when pollen granules from an anther on the stamen are transferred to a stigma on the pistil. Generally, there are two types of pollination that relate to the plants involved: self-pollination and cross-pollination. Self-pollination relates to pollination that occurs when a plant pollinates itself (i.e., pollen granules from the anther are transferred to the stigma on the same plant). Cross-pollination relates to pollination that occurs when a plant pollinates with another plant of the same species (i.e., pollen granules from the anther of one plant are transferred to the stigma of a different plant). With respect to cross-pollination, a vector (e.g., a pollinator or wind) is required as a vehicle for the pollen to travel from one plant to another. Once properly pollinated, a plant begins the process of producing seeds consistent with the genetic information received from the accepted pollen. The produced seeds may correspond to a reproduction of the same plant or a hybrid plant depending on the plants involved in the pollination process.

### SUMMARY

According to one embodiment, a method, computer system, and computer program product for flora yield prediction is provided. The embodiment may include identifying a plurality of florae and a location of each flora within the plurality of florae within a preconfigured space. The embodiment may also include identifying one or more attributes of each flora. The embodiment may further include generating a neural network model based on the plurality of florae, the location of each flora, and the one or more identified attributes. The embodiment may also include calculating tensors from an anther of each flora to one or more stigmas of each other flora within the plurality of florae based on the generated neural network model. The embodiment may further include performing cross-pollination of the plurality of florae based on the calculated tensors.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a predictive yield cross-pollination process according to at least one embodiment.

FIG. 3 illustrates an operational flowchart for a predictive yield analysis and training process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to the artificial pollination. The following described exemplary embodiments provide a system, method, and program product to, among other things, implement artificial intelligence-assisted cross-pollination of florae in a greenhouse environment. Therefore, the present embodiment has the capacity to improve the technical field of artificial pollination by utilizing AI-assisted robotic devices to perform cross-pollination in a greenhouse farming environment to increase flora yields and desirable traits.

As previously described, pollination relates to the fertilization of a plant that occurs when pollen granules from an anther on the stamen are transferred to a stigma on the pistil. Generally, there are two types of pollination that relate to the plants involved: self-pollination and cross-pollination. Self-pollination relates to pollination that occurs when a plant pollinates itself (i.e., pollen granules from the anther are transferred to the stigma on the same plant). Cross-pollination relates to pollination that occurs when a plant pollinates with another plant of the same species (i.e., pollen granules from the anther of one plant are transferred to the stigma of a different plant). With respect to cross-pollination, a vector (e.g., a pollinator or wind) is required as a vehicle for the pollen to travel from one plant to another. Once properly pollinated, a plant begins the process of producing seeds consistent with the genetic information received from the accepted pollen. The produced seeds may correspond to a reproduction of the same plant or a hybrid plant depending on the plants involved in the pollination process.

Cross-pollination has many advantages in farming. Among these advantages is genetics recombination, which relates to the origin of new plant varieties as pollination between flowers of two different plant species occurs. Additionally, offspring created through cross-pollination may exhibit the benefits of heterosis, or hybrid vigor, which relates to enhanced traits as a result of combining genetic contributions. Aspects of heterosis include, but are not limited to, healthier, more viable, and more resistant offspring. Furthermore, the cross-pollinated plants tend to produce seeds in greater quantities and with increased viability. Cross-pollination also demonstrates higher crop yields, increased plant varieties resulting in the origin of disease-resistance, reduction or elimination of undesirable characteristics, and possible emergence of more desirable characteristics.

Unfortunately, despite the many advantages of cross-pollination, many disadvantages are also present. For example, cross-pollination depends on several variables, such as pollination agents and vectors, for successful fertilization. From an economic standpoint, cross-pollination is not beneficial due to a high waste rate of pollen granules and the energy expenditure by plants on various contrivances to ensure the success of cross-pollination, such as flower production that attracts pollination agents (e.g., large, showy, scented flowers that produce sweet nectar). Furthermore, despite cross-pollination being capable of reducing or eliminating undesirable characteristics and creating new desirable characteristics, cross-pollination may also introduce undesirable characteristics into a plant species. As such, it may be advantageous to, among other things, reduce, and/or eliminate the disadvantages of cross-pollination through the utilization of artificial intelligence by analyzing a preconfigured area of florae in a greenhouse environment for desirable attributes and facilitating cross-pollination of specific, identified flora through robotic pollination devices.

According to one embodiment, a predictive yield program may facilitate the transfer of pollen granules from one flower to another in a farming environment with visual recognition-enabled robotic devices capable of multi-modal interaction between a central AI platform before and during transfer. The predictive yield program may begin the process of cross-pollination facilitation through a semantic environment analysis with an image recognition model or deep neural networks to holistically analyze the farming space while tagging each plant and its position in relation to one another. The predictive yield program may then analyze the pollen health of each plant using deep learning convolutional neural networks built on automatically extracted pollen images fed from camera-fitted robotic devices. The predictive yield program may pre-process, normalize, and segment the captured images to extract the target objects (i.e., flower and pollen). Using models pre-trained on extracted features of healthy and unhealthy pollens from multiple flowers to classify the health with a health index, the predictive yield program may categorize each anatomically weak and strong pollens so that neural models can provide instructions on whether the plant can be considered to take pollen and also which plants should be considered for receiving the pollen granules. Upon determining the health of each pollen set, the predictive yield program may calculate a tensor of all anthers and a tensor of all stigmas within the farmed area for cross-pollination prediction. The predictive yield program may feed the prediction to robotic pollination devices to facilitate the transfer of pollen granules from the anther of one plant to the stigma of another plant of the same species.

In at least one embodiment, the robotic pollination devices may rely on a prediction from neural network models to predict an optimal anther from which to obtain pollen and an optimal stigma to deposit pollen based on the position of each flower in relation to each other within the farmed area. To facilitate this prediction and calculation, the predictive yield program may train the neural model on different combinations of anthers and stigmas labelled with a pollination effectiveness index. The predictive yield program may artificially generate the labels based on a closed environment analysis of pollens with different synthesized features.

In another embodiment, the predictive yield program may utilize the robotic pollination devices, or other robotic devices capable of image capture, to identify specific plants that were the subject of cross-pollination and monitor plant growth rates and yield rates of those plants. Accordingly, the predictive yield program may create a knowledge corpus relating to the cross-pollination events and utilize the knowledge corpus for future identification of plants within the farmed area that are characteristically and historically advantageous candidates for cross-pollination.

In yet another embodiment, the predictive yield program may dynamically control airflow within the greenhouse to implement and/or assist in cross-pollination if robotic pollination devices are not available.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

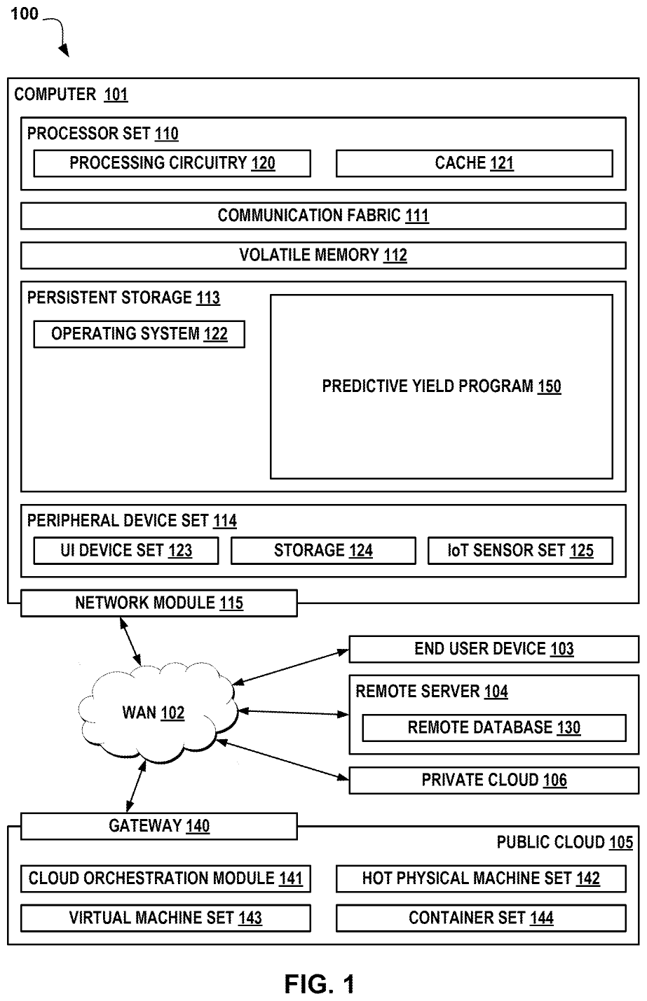

Referring now to FIG. 1, computing environment 100 contains an example of an environment for the execution of at least some of the computer code involved in performing the inventive methods, such as predictive yield program 150. In addition to predictive yield program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and predictive yield program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in predictive yield program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in predictive yield program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

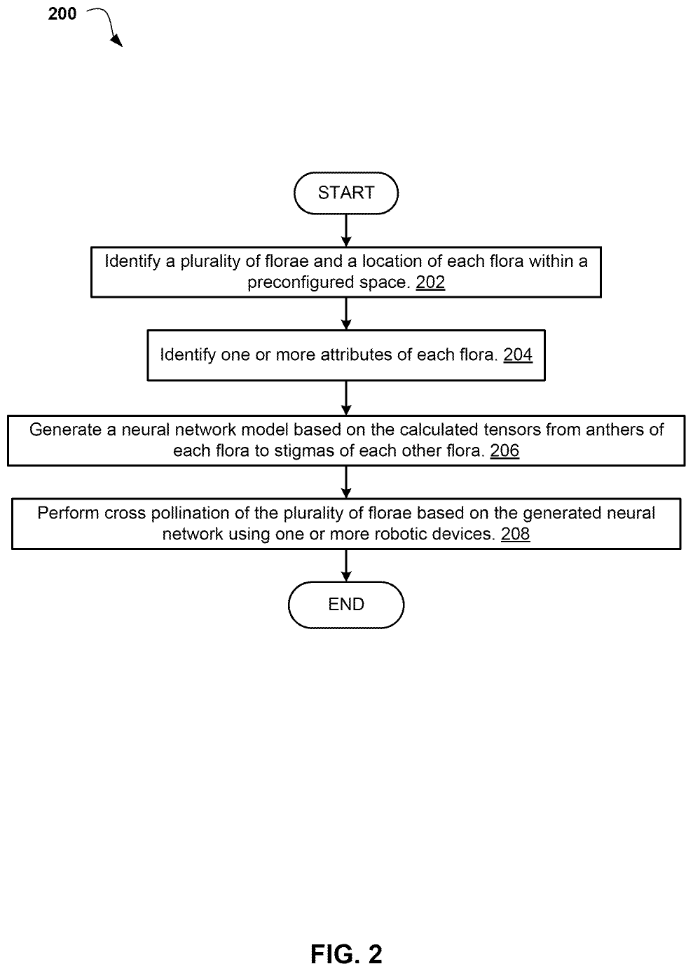

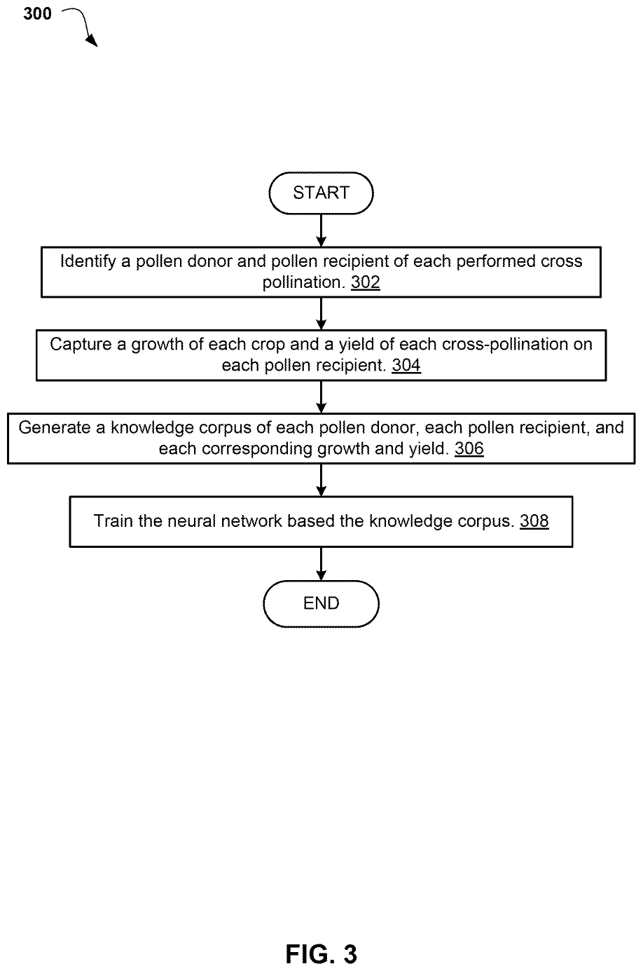

According to at least one embodiment, the predictive yield program 150 may analyze a greenhouse space to identify florae growing within the space, a location of each flora within the space and in relation to each other, and attributes of each flora. The predictive yield program 150 may also calculate tensors from one or more anthers on each flora to each stigma on each other flora within the space. The predictive yield program 150 may generate a neural network based on the calculated tensors, locations, and attributes and instruct one or more robotic pollinators to cross-pollinate the flora within the greenhouse space based on the generated neural network. Additionally, the predictive yield program 150 may monitor the growth of each flora and fruit produced through cross-pollination as well as the yield of each cross-pollinated flora. The predictive yield program 150 may store the growth and yield information of each cross-pollinated flora in a knowledge corpus with information associated with the cross-pollination event and use the knowledge corpus for training the neural network for future cross-pollination events. Furthermore, notwithstanding depiction in computer 101, the predictive yield program 150 may be stored in and/or executed by, individually or in any combination, end user device 103, remote server 104, public cloud 105, and private cloud 106. The predictive yield method is explained in more detail below with respect to FIGS. 2 and 3.

Referring now to FIG. 2, an operational flowchart for a predictive yield cross-pollination process 200 is depicted according to at least one embodiment. At 202, the predictive yield program 150 identifies florae and a location of each flora within a farmed area. The predictive yield program 150 may utilize image recognition and a deep neural network to analyze the farmed area to identify florae present. The farmed area may be any preconfigured, indoor space that has a controlled climate utilized for cultivating and farming of florae, such as a greenhouse. The florae may be any plant that is being grown for farming purposes within the farmed area. Although florae are referenced throughout, in at least one other embodiment, the predictive yield program 150 may also identify and enable cross-pollination of any entity capable of reproduction through cross-pollination.

The predictive yield program 150 may utilize image recognition technology on images captured using one or more sensors within IoT sensor set 125, such as image capture devices, to identify each flora within the farmed area. For example, through image recognition, the predictive yield program 150 may identify a phylum, class, order, family, genus, and/or species of each flora within the farmed area. Furthermore, the predictive yield program 150 may also utilize image recognition technology to identify a location of each flora within the farmed area and a relation to and/or a distance between each other flora within the farmed area. In at least one embodiment, the predictive yield program 150 may create one or more bounding boxes of each flora and its corresponding geographical coordinates, as determined from a global positioning system (GPS) or through triangulation within the farmed area. The predictive yield program 150 may utilize the created bounding boxes in step 204 when identifying one or more attributes of each flora. Once a flora has been identified and a location determined, the predictive yield program 150 may tag each flora with the identification, location, and relational information.

Then, at 204, the predictive yield program 150 identifies one or more attributes of each flora. The predictive yield program 150 may identify one or more attributes associated with a flora, such as, but not limited to, pollen size, pollen amount, flower size, flower color, leaf size, leaf color, number of flowers, number of anthers, number of stigmas, number of leaves. The identification may involve a two-stage process where a pre-training stage may first determine which attributes of a particular species of flora are preferred for cross-pollination and a second stage may proceed with determining whether the florae within the farmed area exhibit the preferred attributes of the pre-trained model through a grading process.

The predictive yield program 150 may pre-train the deep learning convolutional neural network model on extracted attributes and features of healthy and diseased pollens and flowers from multiple flora species in order to classify an overall flora health within a health index. The predictive yield program 150 may identify the attributes of a healthy flora preferential for cross-pollination through one or more repositories, such as storage 124 or remote database 130.

Furthermore, the predictive yield program 150 may receive images captured by robotic devices and/or IoT sensors, such as IoT sensor set 125, distributed throughout the farmed area and utilize a deep learning convolutional neural network model to extract information about the florae within each captured image (e.g., spatial features and dimensions). The raw, captured images may be pre-processed, normalized, and segmented to extract target objects (e.g., flowers and pollens) within each image. The predictive yield program 150, utilizing the deep learning convolutional neural network model, may grade the health of each flora along a health index based on a calculated value determined by the deep learning convolutional neural network model through a comparison of the captured, raw image of a flora to the training images of florae within the same species. The predictive yield program 150 may also utilize the grading to categorize and label anatomically weak and strong pollens based on flora characteristics. The predictive yield program 150 may utilize the grading to determine whether certain florae should be considered as prospective candidates for cross-pollination. For example, the predictive yield program 150 may grade florae with large flower size, pollen size and/or avoided by insets as being favorable characteristics for cross-pollination and, as such, grade a specific flora with those characteristics accordingly on the health index. Conversely, the predictive yield program 150 may grade flora exhibiting disease (e.g., blight or powdery mildew) or deformations (e.g., small flower and leaf growth) as having less favorable characteristics for cross-pollination. In at least one embodiment, the predictive yield program 150 may tag florae with a grading satisfying a threshold as candidates for cross-pollination and tag florae with a grading not satisfying a threshold as not candidates for cross-pollination.

In one or more embodiments, the predictive yield program 150 may perform a tiered grading of spatial features where only florae with a spatial feature graded above a threshold value along a health index may be advanced for further analysis of other spatial features. For example, the predictive yield program 150 may identify florae with flowers receiving a grade along the health index satisfying a threshold value and move those identified flora along for grading of other spatial features (e.g., pollen) while discarding any florae in the same dataset with flowers receiving a grade along the health index that do not satisfy the threshold value.

Next, at 206, the predictive yield program 150 generates a neural network model based on the calculated tensors from anthers of each flora to stigmas of each other flora. A tensor may relate to an algebraic object describing a multilinear relationship between objects in a vector space. The predictive yield program 150 may ingest florae with categorized and labelled spatial features deemed preferred for cross-pollination into a deep neural network to generate a model that calculates one or more traversal paths from anthers of one or more florae to the stigmas of one or more other florae with corresponding position, flower, and pollen labels. In at least one embodiment, the predictive yield program 150 may also consider optimal air flow magnitude and direction so that the pollination devices, if aerial-based, can consider such information in a closed environment.

In one or more other embodiments, the predictive yield program 150 may depend on an additional stage of the deep neural network model which may predict an optimal path from flora anthers to corresponding flora stigmas. The predictive yield program 150 may achieve this determination by training the deep neural network model on various combinations of anthers and stigmas categorized and labelled under the health index described in step 204. In at least one embodiment, these labels may be artificially generated based on a closed environment analysis of pollens with different synthesized features as may be performed in a research experiment.

In at least one other embodiment, rather than generate a neural network, the predictive yield program 150 may utilize an existing neural network from previous iterations that has been trained according to step 308 discussed below.

Next, at 208, the predictive yield program 150 performs cross-pollination of the florae based on the generated neural network using one or more robotic devices. Once the traversal path is predicted, the predictive yield program 150 may transmit each traversal path to robotic pollination devices that are then deployed to collect pollen from the flora anthers and deposit the collected pollen in flora stigmas corresponding to the traversal paths thereby ensuring cross-pollination according to the deep learning convolutional neural network model. A robotic pollination device may be any device previously described with respect to computer 101 that is capable of communicating across WAN 102, self-traversal of the farmed area, and capturing and depositing pollen granules from flora anthers and flora stigmas, respectively. As previously described, the robotic pollination device may include one or more sensors from IoT sensor set 125, such as a camera. IoT sensor set 125 may further include, but is not limited to, proximity sensors, accelerometers, infrared sensors, pressure sensors, light sensors, ultrasonic sensors, touch sensors, color sensors, humidity sensors, position sensors, magnetic sensors (e.g., Hall effect sensor), sound sensors (e.g., microphones), tilt sensors (e.g., gyroscopes), flow sensors, level sensors, strain sensors, and weight sensors. In one or more embodiments, the robotic pollination device may include aerial and/or ground traversal capabilities.

Upon receiving the information related to the traversal paths, the predictive yield program 150 may instruct each robotic pollination device to perform pollination through the capture of pollen granules from the identified anthers of one flora and depositing the captured pollen granules on the stigmas of the one or more identified stigmas.

Referring now to FIG. 3, an operational flowchart for a predictive yield analysis and training process 300 according to at least one embodiment. At 302, the predictive yield program 150 identifies a pollen donor and a pollen recipient of each performed cross-pollination. The pollen donor may be a flora within the farmed area from which the robotic pollination device captured pollen granules in order to deposit on another flora's stigma thereby effectuating cross-pollination. The pollen recipient may be a flora, different from the pollen donor, within the farmed area at which the pollen granules, captured from the pollen donor, are deposited on a corresponding stigma. Upon effectively depositing the pollen granules on the stigma(s), the predictive yield program 150 may identify the pollen donor and pollen recipient as well as other cross-pollination information.

In at least one other embodiment, the predictive yield program 150 may also capture information related to the cross-pollination event, or cross-pollination statistics, such as, but not limited to, pollen donor location within the farmed area, pollen recipient location within the farmed area, pollen anther source, pollen stigma recipient, pollen donor location in relation to the pollen recipient, anther dimensions, pollen granule dimensions, stigma dimensions, pollen donor flower dimensions, pollen recipient flower dimensions, cross-pollination date, cross-pollination time, environmental information at time of cross-pollination, robotic pollination device effectuating the cross-pollination event, amount of pollen granules deposited on the stigma, a time period since first bloom of the pollen donor flower, and a time period since first bloom of the pollen recipient flower.

Next, at 304, the predictive yield program 150 captures a growth of each crop and a yield of each cross-pollination on each pollen recipient. After cross-pollination and generation of the knowledge corpus, the predictive yield program 150 may continually monitor each pollen recipient for various post-pollination statistics, such as, but not limited to, actual acceptance of the deposited pollen, growth rate of the fruit, fruit yield of each flora, days to harvest from fertilization, size of each fruit at time of harvest, health of fruit at harvest, health of plant at time of fruit harvest, taste metrics of each harvested fruit (e.g., sweetness, sourness, bitterness, etc.). The predictive yield program 150 may update the knowledge corpus with the captured post-pollination statistics.

Then, at 306, the predictive yield program 150 generates a knowledge corpus of each pollen donor, each pollen recipient, and each corresponding growth and yield. Upon identifying the pollen donor, pollen recipient, cross-pollination information, and post-pollination statistics, the predictive yield program 150 may store the pollen donor, pollen recipient, cross-pollination information, and post-pollination statistics in a repository, such as storage 124 and/or remote database 130. In at least one embodiment, the predictive yield program 150 may further include the florae identification and location information from step 202 and the florae attribute information from step 204 in the generated knowledge corpus.

Then, at 308, the predictive yield program 150 trains the neural network based on each analyzed growth and yield of the cross-pollination. Once the knowledge corpus is updated with the post-pollination statistics, the predictive yield program 150 may correlate the post-pollination statistics with the florae information and locations from step 202, the florae attributes from step 204, and the cross-pollination information from step 304 in order to identify any statistical significances within the post-pollination statistics. The predictive yield program 150 may train the neural network used to calculate tensors in step 206 more effectively based on the specific characteristics of the florae and farmed area thereby further improving the resultant post-pollination statistics (e.g., fruit growth rates, fruit growth size, and yield).

It may be appreciated that FIGS. 2 and 3 provide only an illustration of one implementation and do not imply any limitations with regard to how different embodiments may be implemented. Many modifications to the depicted environments may be made based on design and implementation requirements. In at least one embodiment, the predictive yield program 150 may monitor flower buds on the florae within the farmed area in order to track a blooming period of each flower.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a plurality of florae and a location of each flora within the plurality of florae within a preconfigured space;
identifying one or more attributes of each flora;
generating a neural network model based on the plurality of florae, the location of each flora, and the one or more identified attributes;
calculating tensors from an anther of each flora to one or more stigmas of each other flora within the plurality of florae based on the generated neural network model; and
performing cross-pollination of the plurality of florae based on the calculated tensors.

2. The method of claim 1, further comprising:
identifying a pollen donor and a pollen recipient of each performed cross-pollination;
capturing a growth of each crop and a yield of each cross-pollination on each pollen recipient;
generating a knowledge corpus of each pollen donor, each pollen recipient, and each corresponding growth and yield; and
training the generated neural network based on the knowledge corpus.

3. The method of claim 1, wherein generating the neural network model further comprises:
calculating a health grade for each flora based on the one or more identified attributes using a deep learning convolutional neural network.

4. The method of claim 3, wherein the calculation further comprises:
comparing a captured, raw image of each flora to one or more training images of florae within the same species; and
assigning a numerical value to each flora corresponding to a difference between the captured, raw image and the one or more training images.

5. The method of claim 4, wherein calculating the tensors is only performed for each flora with an assigned numerical value satisfying a threshold representative of flora health.

6. The method of claim 1, wherein the one or more attributes are selected from a group consisting of pollen size, pollen amount, flower size, flower color, leaf size, leaf color, number of flowers, number of anthers, number of stigmas, number of leaves.

7. The method of claim 1, wherein the cross-pollination is performed by transmitting one or more traversal paths from anthers of one or more florae within the plurality of florae to stigmas of one or more other florae within the plurality of florae to one or more robotic pollination devices.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a plurality of florae and a location of each flora within the plurality of florae within a preconfigured space;
identifying one or more attributes of each flora;
generating a neural network model based on the plurality of florae, the location of each flora, and the one or more identified attributes;
calculating tensors from an anther of each flora to one or more stigmas of each other flora within the plurality of florae based on the generated neural network model; and
performing cross-pollination of the plurality of florae based on the calculated tensors.

9. The computer system of claim 8, further comprising:
identifying a pollen donor and a pollen recipient of each performed cross-pollination;
capturing a growth of each crop and a yield of each cross-pollination on each pollen recipient;
generating a knowledge corpus of each pollen donor, each pollen recipient, and each corresponding growth and yield; and
training the generated neural network based on the knowledge corpus.

10. The computer system of claim 8, wherein generating the neural network model further comprises:
calculating a health grade for each flora based on the one or more identified attributes using a deep learning convolutional neural network.

11. The computer system of claim 10, wherein the calculation further comprises:
comparing a captured, raw image of each flora to one or more training images of florae within the same species; and
assigning a numerical value to each flora corresponding to a difference between the captured, raw image and the one or more training images.

12. The computer system of claim 11, wherein calculating the tensors is only performed for each flora with an assigned numerical value satisfying a threshold representative of flora health.

13. The computer system of claim 8, wherein the one or more attributes are selected from a group consisting of pollen size, pollen amount, flower size, flower color, leaf size, leaf color, number of flowers, number of anthers, number of stigmas, number of leaves.

14. The computer system of claim 8, wherein the cross-pollination is performed by transmitting one or more traversal paths from anthers of one or more florae within the plurality of florae to stigmas of one or more other florae within the plurality of florae to one or more robotic pollination devices.

15. A computer program product, the computer program product comprising:
one or more computer-readable tangible storage medium and program instructions stored on at least one of the one or more tangible storage medium, the program instructions executable by a processor capable of performing a method, the method comprising:
identifying a plurality of florae and a location of each flora within the plurality of florae within a preconfigured space;
identifying one or more attributes of each flora;
generating a neural network model based on the plurality of florae, the location of each flora, and the one or more identified attributes;
calculating tensors from an anther of each flora to one or more stigmas of each other flora within the plurality of florae based on the generated neural network model; and
performing cross-pollination of the plurality of florae based on the calculated tensors.

16. The computer program product of claim 15, further comprising:
identifying a pollen donor and a pollen recipient of each performed cross-pollination;
capturing a growth of each crop and a yield of each cross-pollination on each pollen recipient;
generating a knowledge corpus of each pollen donor, each pollen recipient, and each corresponding growth and yield; and
training the generated neural network based on the knowledge corpus.

17. The computer program product of claim 15, wherein generating the neural network model further comprises:
calculating a health grade for each flora based on the one or more identified attributes using a deep learning convolutional neural network.

18. The computer program product of claim 17, wherein the calculation further comprises:
comparing a captured, raw image of each flora to one or more training images of florae within the same species; and
assigning a numerical value to each flora corresponding to a difference between the captured, raw image and the one or more training images.

19. The computer program product of claim 18, wherein calculating the tensors is only performed for each flora with an assigned numerical value satisfying a threshold representative of flora health.

20. The computer program product of claim 15, wherein the one or more attributes are selected from a group consisting of pollen size, pollen amount, flower size, flower color, leaf size, leaf color, number of flowers, number of anthers, number of stigmas, number of leaves.
